(19) United States
(12) Patent Application Publication
(10) Pub. No.: US 2026/0146672 A1
(43) Pub. Date: May 28, 2026

(54) PRESSURE ACTIVATED NON-CONTACT SEALS AND SEAL ASSEMBLIES

(71) Applicant: Cross Manufacturing Company (1938) Limited, Bath Somerset (GB)

(72) Inventors: Peter Francis Crudgington, Bath Somerset (GB); Robert Proctor, Mason, OH (US); Andrew Pawlak, Devizes Wiltshire (GB)

(21) Appl. No.: 19/122,861

(22) PCT Filed: Oct. 19, 2023
(86) PCT No.: PCT/GB2023/052720

§ 371 Date: Apr. 21, 2025

(30) Foreign Application Priority Data
Oct. 21, 2022 (GB) 2215665.7

(51) Int. Cl. F16J 15/44; F16J 15/447

(52) U.S. Cl. CPC F16J 15/442; F16J 15/443; F16J 15/4472

(57) ABSTRACT

A pressure activated non-contact seal for sealing against a rotating cylindrical surface between a high-pressure region and a low-pressure region comprises a seal member carrier spaced from the rotating surface defining a seal member chamber in fluid communication with the high-pressure region. A seal member is supported by the seal member carrier to be radially moveable. A secondary seal is mounted between the surface of the seal member and a surface of the seal member chamber to provide a pressure barrier around the seal member. The seal member comprises side walls extending towards the rotating surface to define a seal cavity. The ends of the side walls define non-contact seal surfaces. The seal member further comprises a bleed port extending between the seal cavity and the seal member chamber on the high-pressure side of the secondary seal. In use, high pressure in the seal member chamber urges the seal member towards the rotating surface until balanced by the pressure in the seal cavity to maintain the non-contact seal surfaces in a non-contact sealing relationship with the rotating surface. A seal assembly comprises multiple seals arranged circumferentially around the rotating surface.

### FIELD

This invention relates to seals and seal assemblies. In particular, the invention relates to pressure activated non-contact seals. The invention also relates to seal assemblies comprising an arrangement of multiple seals.

### BACKGROUND

Seals can be used to provide a pressure barrier around a rotating shaft, such as the shaft of a turbine. In turbines such as gas turbines, it is often necessary to have a shaft that extends through regions of differing fluid pressure, and that seal are provided to maintain the pressure in these regions. One form of seal is a brush seal in which a bunch of filaments extends between the seal and the rotating shaft to maintain a small spacing to ensure a pressure barrier is maintained. As the filaments wear, sealing performance is degraded and eventually the seals must be replaced.

Wear is a problem for any form of contact seal.

An object of this invention is to provide a non-contact seal, i.e. one which maintains a small separation between the seal and the shaft that is sufficient to allow rotation while still ensuring an appropriate pressure barrier. It is also desirable that the seal be pressure activated, i.e. that the seal is formed when the pressure across the seal raises to a given level.

### SUMMARY

A first aspect of the invention comprises a pressure activated non-contact seal for sealing against a rotating cylindrical surface, such as around the outside of a rotating shaft, between a high-pressure region and a low-pressure region, comprising: a seal member carrier spaced radially from the rotating cylindrical surface and defining a seal member chamber in fluid communication with the high-pressure region; a seal member supported by the seal member carrier so as to be moveable in a radial direction of the rotating cylindrical surface, and comprising non-contact seal surfaces adjacent to the rotating cylindrical surface; and a secondary seal mounted between a surface of the seal member facing the seal member carrier, such as the outer surface of the seal member and an opposed surface, such as the inner surface, of the seal member chamber to provide a pressure barrier around the seal member between the high-pressure region and the low-pressure region; wherein the seal member comprises side walls extending in the radial direction towards the rotating cylindrical surface and defining a seal cavity, the ends of the side walls, such as the radially inner ends, defining non-contact seal surfaces adjacent to the rotating cylindrical surface; and the seal member further comprises a bleed port extending between the seal cavity and the seal member chamber outside the seal member on the high-pressure side of the secondary seal such that in use, high pressure in the seal member chamber urges the seal member towards the shaft until balanced by the pressure in the seal cavity to maintain the non-contact seal surfaces in a non-contact sealing relationship with the shaft.

The rotating cylindrical surface can be the outer surface of a rotating shaft or cylinder, or the inner surface of a rotating hollow cylinder or hollow shaft.

In use, a high pressure in the seal member chamber urges the seal member towards the rotating cylindrical surface, moving the seal surfaces closer to the rotating cylindrical surface. The pressure in the seal cavity also rises due to pressure communication through the bleed port until the pressure in the seal cavity balances the pressure in the seal member chamber to hold the seal surface away from the rotating cylindrical surface.

The seal member side walls can be located at opposite ends of the seal member (i.e. at the high-pressure and low-pressure ends), and one or more intermediate walls can be located between the side walls to define multiple seal cavities. The seal can further comprise a bleed port extending between each seal cavity and the seal member chamber around the seal member on the high-pressure side of the secondary seal. The sealing behaviour of the seal can be tuned by selecting the size of the seal cavities and bleed port(s).

The secondary seal can be mounted on the seal member and urged against the opposed wall, such as an inner wall of the seal member chamber (i.e. outwardly sprung). Alternatively, the secondary seal can be mounted on the wall of the seal member chamber and urged against an opposed wall, such as an outer surface of the seal member, facing the seal member carrier (i.e. inwardly sprung).

The secondary seal can be located at a position between the high-pressure end and the-low pressure end of the seal member. The exact position will determine how much of the outer surface of the seal member is exposed to high pressure.

The surface of the seal member facing the seal member carrier can be extended in a radial direction to define an axially-facing surface portion, the opposed surface of the seal member chamber having a corresponding axially-facing surface portion, and the secondary seal can be mounted between the two axially-facing surface portions.

The seal member carrier can comprise an end wall located at the low-pressure end of the seal member carrier and extending towards the shaft such that the low-pressure end of the seal member abuts against the end wall. This can resist axial movement of the seal member due to the pressure drop across the seal.

The end wall can have a pocket formed facing the low-pressure end of the seal member carrier, wherein the pocket is in pressure communication with the seal member chamber outside the seal member on the high-pressure side of the secondary seal. A pressure port can extend between the pocket and the seal member chamber around, e.g. outside, the seal member on the high-pressure side of the secondary seal, or between the pocket and a seal cavity having a bleed port extending to the seal member chamber outside the seal member on the high-pressure side of the secondary seal. The seal member carrier end wall and the low-pressure end of the seal member can be axially spaced from the non-contact seal surfaces.

Alternatively, the seal member carrier can comprise an end wall located at the high-pressure end of the seal member carrier and extending towards the rotating cylindrical surface, and a leaf spring extends between the end wall and the high-pressure end of the seal member. The leaf spring can resist the axial load due to pressure drop across the seal and can guide the movement of the seal member.

The leaf spring can comprise a pair of leaf springs spaced apart in a radial direction.

A second aspect of the invention comprises a seal assembly comprising multiple seals arranged circumferentially around the rotating cylindrical surface.

The seal assembly can further comprise a seal carrier, and each seal can comprise a formation that engages with a corresponding formation on the seal carrier to resist rotational movement of the seal. This can assist in preventing the seals rotating with the rotating cylindrical surface.

The seal assembly can further comprise springs, such as coil springs or leaf springs between adjacent seals arranged to urge the adjacent seals apart.

This will cause the seals to be pushed away from the rotating cylindrical surface when not activated by high pressure.

The edges of adjacent seals can be stepped and the stepped edges inter-engaged to prevent a direct path extending between adjacent seals. The steps can be in the radial and/or axial directions.

Further aspects of the invention are described below in relation to the drawings.

### DESCRIPTION OF THE DRAWINGS

FIGS. 1 and 2 show a first embodiment of a seal in an inactivated state and an activated state.

FIGS. 3 and 4 show alternative forms of a sealing member for the embodiment of FIGS. 1 and 2.

FIGS. 5 and 6 show further alternative forms of a sealing member for the embodiment of FIGS. 1 and 2.

FIG. 7 and 8 show still further alternative forms of a sealing member for the embodiment of FIGS. 1 and 2.

FIG. 9 shows an end view of sealing members as shown in FIG. 7 or 8.

FIG. 10 shows a partial view of a seal assembly according to the invention.

FIGS. 11 and 12 show alternative embodiments of the seal assembly of FIG. 10.

FIGS. 13 and 14 show axial and radial partial views of adjacent seals in an assembly.

FIGS. 15 and 16 show a second embodiment of a seal in an inactivated state and an activated state.

FIGS. 17 and 18 show an alternative form of the embodiment of FIGS. 15 and 16.

FIG. 19 shows details of the embodiment of FIGS. 15 to 18.

FIG. 20 shows a variant of the type of seal shown in FIGS. 1 to 8.

FIG. 21 shows a variant corresponding to that of FIG. 20 for of the type of seal shown in FIGS. 15 to 18.

FIGS. 22 and 23 show partial views of an embodiment of a seal member.

FIG. 24 shows a variant of the embodiment of FIG. 20.

FIG. 25 shows a further variant of FIG. 20.

### DETAILED DESCRIPTION

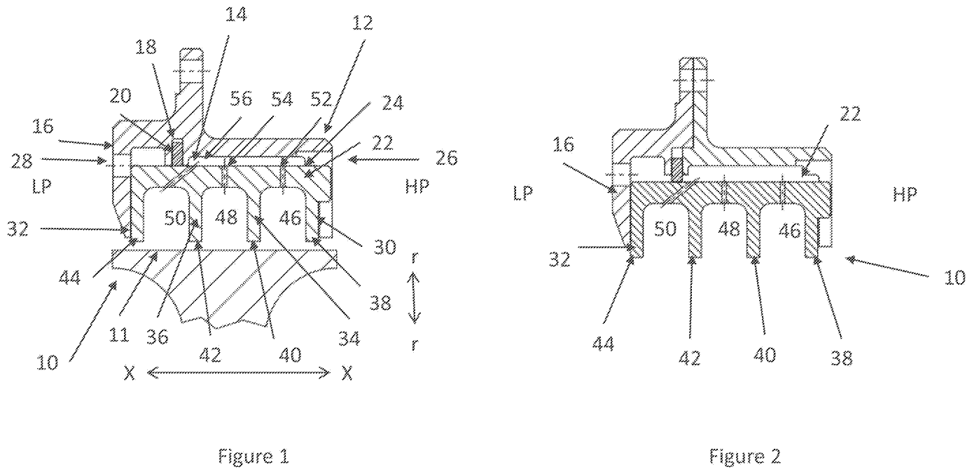

The seal shown in FIGS. 1 and 2 is a cross-section through a seal for use with a rotating cylindrical shaft 10 such as a shaft extending through a gas turbine between a high-pressure region HP and a low-pressure region LP that rotates about an axis X-X. The seal comprises a seal member carrier 12 spaced from the shaft 10. The inner part of the seal member carrier 12 defines a seal member chamber 14. The low-pressure end of the seal member carrier 12 has an end wall 16 extending towards the shaft 12. A locating grove 18 is provided in the inner wall of the seal member chamber 14 and an inwardly sprung secondary sealing ring 20 is mounted in the groove 18. FIG. 2 shows an embodiment in which the seal member carrier 12 is made in two parts for ease of assembly. In this case, the groove 18 can be formed at the interface between the two parts.

A seal member 22 is located in the seal member chamber 14 so as to be moveable in the radial direction r-r. The secondary sealing ring 20 is urged into contact with the outer surface 24 of the seal member 22 facing the seal member carrier 12 to form a pressure barrier part way along the seal member chamber 14. The seal member carrier 12 is open to the high-pressure fluid at one end 26, and to low-pressure fluid at the other end 28. Consequently, the seal member chamber 14 has a high-pressure zone on the high-pressure side of the secondary seal 20 and a low-pressure zone on the low-pressure side of the secondary seal 20.

The seal member 22 has end walls 30, 32 that extend towards the shaft 10. Intermediate walls 34, 36 are located between the end walls 30, 32. The intermediate walls are substantially parallel to the end walls 30, 32. The ends 38, 40, 42, 44 of the end walls 30, 32 and intermediate walls 34, 36 are level with each other and define non-contact seal surfaces. The end walls 30, 32 and intermediate walls 34, 36 define seal cavities 46, 48, 50.

Each cavity 46, 48, 50 communicates with the high-pressure zone of the seal member chamber 14 via a respective bleed port 52, 54, 56.

In use, the seal is in the configuration shown in FIG. 1 due to the effect of springs in the mounting (described below). The pressure at the high-pressure end HP builds. While the spaces between the ends 38, 40, 42, 44 and the bleed ports 52, 54, 56 allow fluid to pass across the seal, the spaces and port sizes are sufficiently small that there is resistance to fluid flow and a pressure drop is created. The effect of this pressure drop is that the higher pressure acting on the outer surface of the seal member 22 urges it towards the shaft 10, closing the space between the ends 38, 40, 42, 44 and the outer surface of the shaft 10. The fluid continues to enter the cavities 46, 48, 50 through the bleed ports 52, 54, 56 but pressure rises due to the reduced spacing of the ends 38, 40, 42, 44 from the cylindrical outer surface 11 of the shaft 10 until the pressure in the cavities 46, 48, 50 balances the pressure in the high-pressure zone acting on the outer surface of the seal member 22. At this point (FIG. 2), the ends 38, 40, 42, 44 are separated from the shaft 10 by a very small distance so there is no contact but still sufficient resistance to fluid flow to maintain the pressure difference across the seal. The seal is self-adjusting; if the space between the ends 38, 40, 42, 44 becomes too small, the pressure in the cavities 46, 48, 50 builds, lifting the seal member 22 away from the shaft until the pressure drops due to the wider spacing.

The seal member carrier end wall 16 prevents axial movement of the seal member 22 due to the pressure drop across the seal by abutting engagement with the low-pressure end wall 32 of the seal member 22.

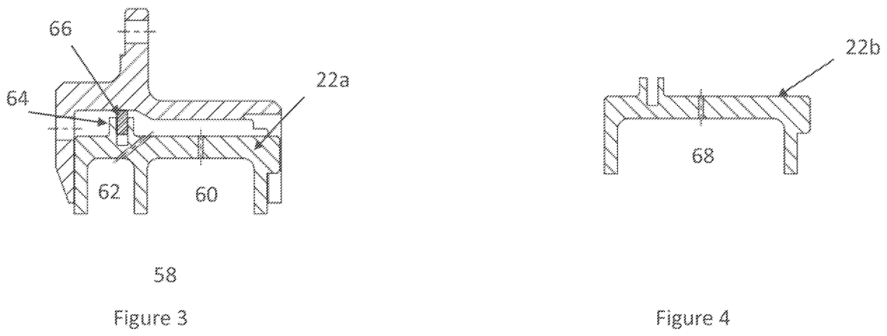

In the embodiment of FIGS. 1 and 2, there are three approximately equal cavities. In other embodiments the number and relative sizes of the cavities can be varied. FIG. 3 shows an embodiment with a seal member 22a having one intermediate wall 58 and two cavities 60, 62. In this case, the intermediate wall 58 is spaced towards the low-pressure end of the seal member 22a so that the cavities are of dissimilar sizes. In addition, instead of the groove 18 in the seal member carrier 12 with an inward sprung seal 20, the seal member 22a has a groove 64 in its outer surface with an outward sprung sealing ring 66 which engages the inner wall of the seal member carrier chamber 14.

FIG. 4 shows an alternative sealing member 22b for use in the embodiment of FIG. 3. In this case there are no intermediate walls and only a single cavity 68.

It is not necessary that a bleed port is provided for each cavity. Also, the dimension of the bleed ports need not be identical. The number and relative sizes of the cavities and bleed ports can be adjusted according to requirements.

The position of the secondary seal between the ends of the seal member carrier chamber defines the size of the high-pressure zone and hence the force that can be applied to the seal member 22.

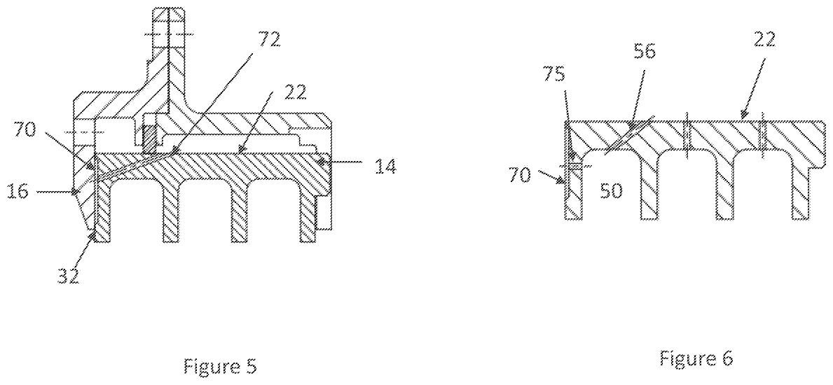

FIG. 5 shows another embodiment similar to that of FIG. 2. As before, the seal member carrier end wall 16 prevents axial movement of the seal member 22 due to the pressure drop across the seal by abutting engagement with the low-pressure end wall 32 of the seal member 22. In use, friction between the end walls 16, 32 might inhibit free movement of the seal member 22. In the embodiment of FIG. 5, the seal member end wall 32 has a pressure balance pocket 70 that faces the seal member carrier end wall 16. The pressure balance pocket 70 is connected to the high-pressure zone of the carrier chamber 14 by means of a pressure balance feed port 72. This reduces the friction between the contact surfaces when pressure is applied across the seal.

An alternative form of seal member 22 is shown in FIG. 6 in which the pressure balance feed port 72 is replaced by an end wall port 74 which connects the pressure balance pocket 70 to the adjacent cavity 50 which in turn is connected to the high-pressure zone of the carrier chamber 14 by means of the bleed feed port 56.

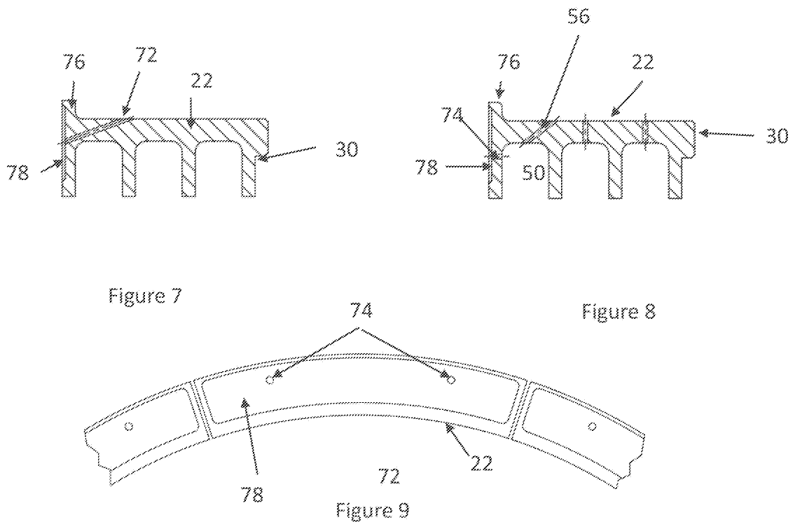

FIGS. 7 and 8 show further variants of the seal member 22 shown in FIGS. 5 and 6. In each case the seal member end wall 32 is replaced by an enlarged end wall 76. This in turn allows for an enlarged pressure balance pocket 78 which has approximately the same area as that of the upstream end wall 30 of the seal member 22. The enlarged pressure balance pocket 78 is connected to the high-pressure zone of the carrier chamber 14 by means of a pressure balance feed port 72 or by an end wall port 74 which connects the pressure balance pocket 70 to the adjacent cavity 50 which in turn is connected to the high-pressure zone of the carrier chamber 14 by means of the bleed feed port 56.

While FIGS. 5 to 8 only show one pressure balance feed port 72 of end wall port 74, more than one can be provided. FIG. 9 shows an end view of the seal member 22 having two pressure balance fed ports 72 opening into enlarged pressure balance pocket 78.

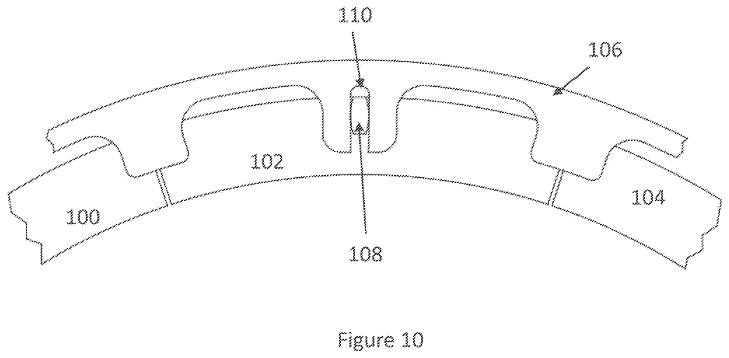

The invention also provides a seal assembly as shown in part in FIG. 10. The seals described above are intended to fit around a rotating shaft. This is achieved by using a plurality of arcuate seal segments 100, 102, 104, each of which comprises a seal such one of those described above and that is held in a circumferential arrangement around the shaft by a seal carrier 106. Each seal has a lug 108 that engages in a slot 110 in the seal carrier 106. The inter-engagement of these formations prevents rotation of the seals with the shaft.

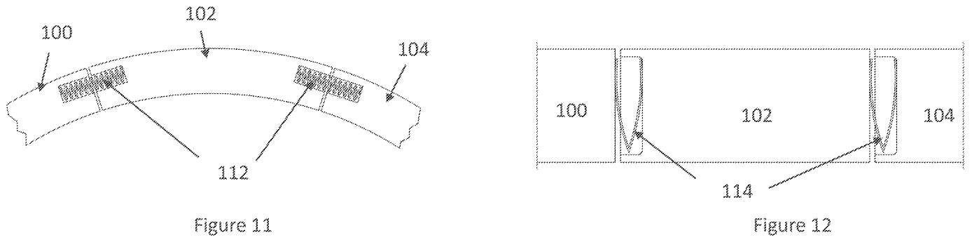

In order to maintain the seals paced away from the shaft at start up, springs are provided between adjacent seals 100, 102, 104 to urge each other apart. These can be coil springs 112 (FIG. 11) or wishbone/leaf springs 114 (FIG. 12).

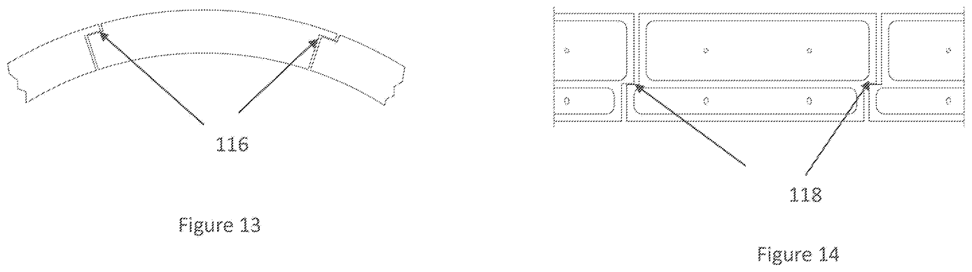

In order to prevent leakage in the gaps between adjacent seals 100, 102, 104, the edges of the seals can be provided with inter-engaging stepped formations. The steps can be in the radial direction 116 (FIG. 13) and/or in the axial direction 118 (FIG. 14).

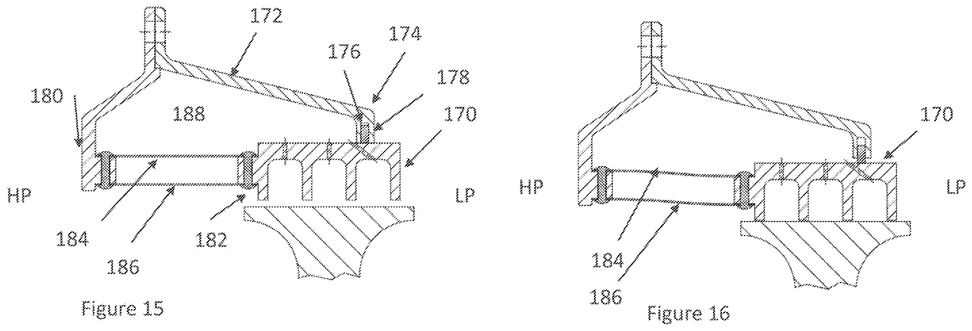

FIGS. 15 and 16 show a second embodiment of a seal according to the invention. In this embodiment, the seal member 170 has generally the same configuration as that of FIG. 1. In this embodiment, the seal member carrier 172 has a different configuration. The low-pressure end 174 of the seal member carrier 172 has a groove 176 mounting the inwardly sprung secondary sealing ring 178. The high-pressure end 180 of the seal member carrier 172 is spaced from the high-pressure end 182 of the seal member 170. A pair of leaf springs 184, 186 extends through the seal member carrier chamber 188 between the high-pressure end 180 of the seal member carrier 172 and the high-pressure end 182 of the seal member 170. The leaf springs 184, 186 are spaced in the radial direction.

The leaf springs 184, 186 resist axial load on the seal member 170 and allow controlled radial movement of the seal member 170 when active by high-pressure so that is remains parallel to the shaft surface (FIG. 16).

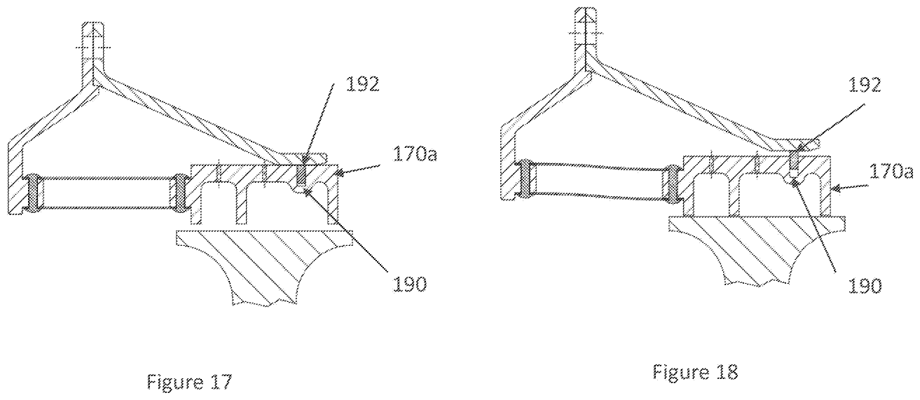

FIGS. 17 and 18 show an alternative embodiment to that shown in FIGS. 15 and 16. In this embodiment, the groove 176 in the carrier 172 and inwardly sprung secondary sealing ring 178 are replaced by a groove 190 in the outer surface of the seal member 170a mounting an outwardly sprung secondary sealing rung 192 which acts on the inner surface of the carrier 172 at the low-pressure end.

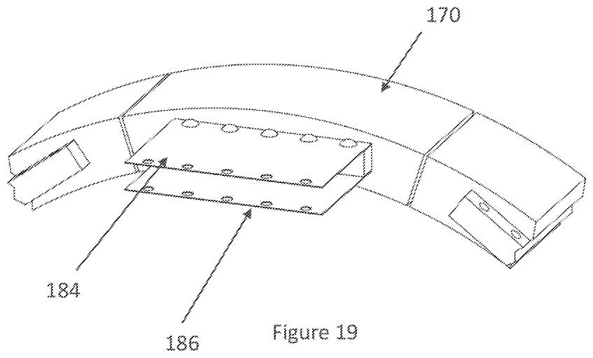

As is described in more detail below, the seal member 170 has an arcuate form. FIG. 19 shows the mounting of the leaf springs 184, 186 on the seal member 170. The leaf springs 184, 186 are planar and act in one plane only.

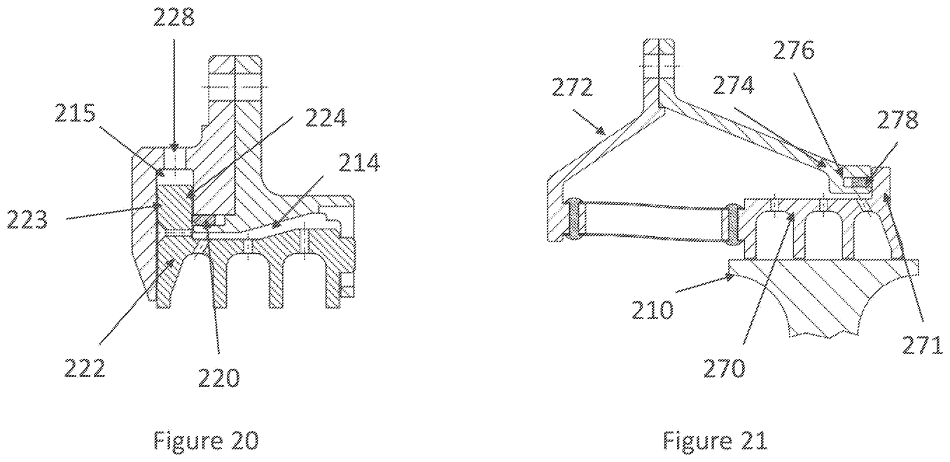

FIG. 20 shows a variant of the type of seal shown in FIGS. 1 to 8. In this embodiment, the low-pressure end 215 of the seal member chamber 214 and the corresponding end 223 of the seal member 222 are extended in a radial direction away from the shaft (not shown). The secondary sealing ring 220 is located in the wall of the extended end 215 of the seal member chamber 214 so as to extend in an axial direction and seal against the corresponding axial face 224 of the extended end 223 of the seal member 222. The secondary sealing ring 220 can be urged against the axial face 224 by spring elements (not shown). The seal member chamber 214 is open to low-pressure fluid at the end 228 as before.

FIG. 21 shows a variant corresponding to that of FIG. 20 but for of the type of seal shown in FIGS. 15 to 18. In this case, the groove 276 in the low-pressure end 274 of the seal member carrier 272 extends in an axial direction. The low-pressure end 271 of the seal member 270 is extended radially away from the shaft 210 such that the secondary sealing ring 278 in the groove 276 seals against the axial face of the end 271 of the seal member 270. Again, spring elements (not shown) can be provided to urge the secondary sealing ring 278 into contact with the end 271.

The variants of FIGS. 20 and 21 may be useful for large-diameter seals where a radially extending ring may become too large to be successfully installed.

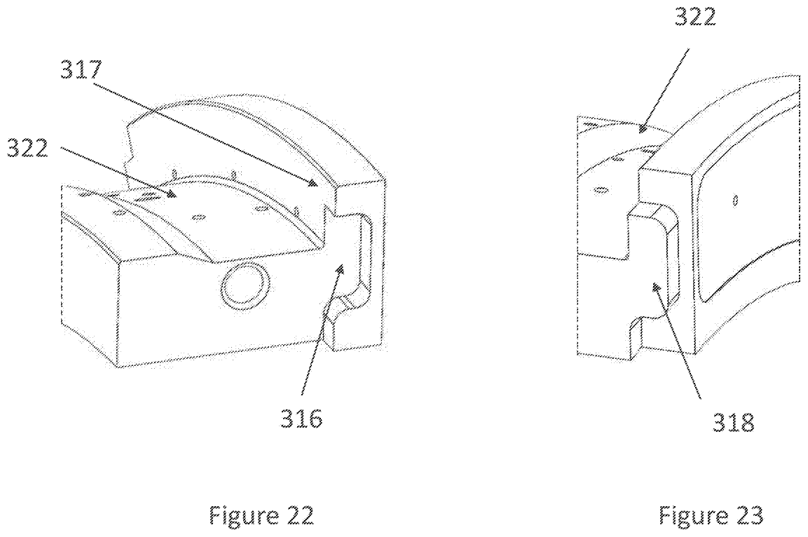

FIGS. 22 and 23 show partial views of an embodiment of a seal member 322 for use as the seal member 222 of FIG. 20 or 270 of FIG. 21. The edges of the seal member 322 are provided with multi-step inter-engaging formations in the form of a cutout 316 and corresponding lug 318. In use, the lug 318 of one seal member 322 engages in the corresponding cutout 316 of an adjacent seal member 322. This engagement assists in sealing the gap between adjacent seal member 322. The secondary sealing ring 220, 278 can seal against the part 317 of the seal member 322 above the cutout 316 to further enhance the sealing effect.

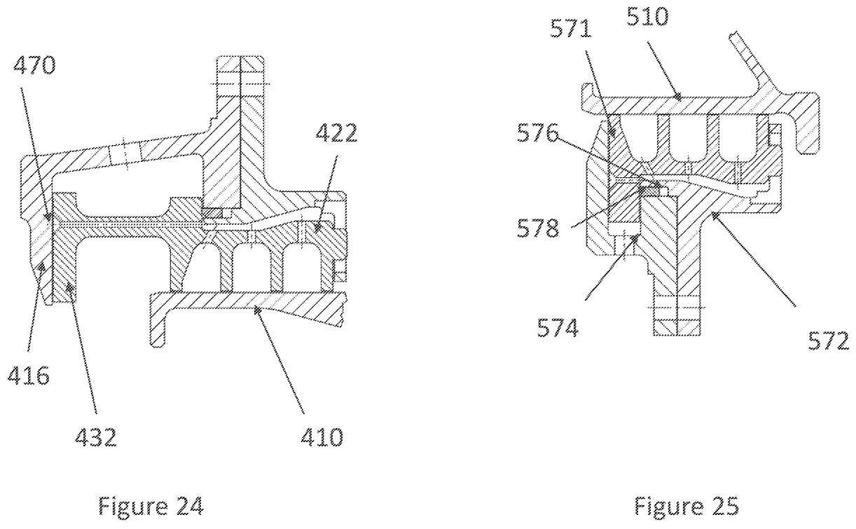

FIG. 24 shows a variant of the embodiment of FIG. 20. In this embodiment, the seal member end wall 432 having the pressure balance pocket 470, and the seal member carrier end wall 416 are extended axially away from the seal member 422 and the shaft 410. This allows the areas of the seal member end wall 432 and the pressure balance pocket 470 to be matched without interference form the seal member 422 or shaft 410. This also allows the centres of pressure of the high-pressure and low-pressure zones to be substantially the same which can reduce any twisting moment on the seal that can arise if the centres of pressure are not aligned. This variant can also apply to the embodiments of FIGS. 1 to 8.

FIG. 25 shows a further variant of FIG. 20. In the previous embodiment, the seals engage against the outer surface of a rotating shaft. In the embodiment of FIG. 25, the seals engage the inner surface of a rotating cylinder or hollow shaft 510 to provide the pressure barrier within the cylinder. Structurally, the same basic elements are present, with the groove 576 in the low-pressure end 574 of the seal member carrier 572 extends in an axial direction. The low-pressure end 571 of the seal member 570 is extended radially away from the cylinder 510 such that the secondary sealing ring 578 in the groove 576 seals against the axial face of the end 571 of the seal member 570. Again, spring elements (not shown) can be provided to urge the secondary sealing ring 578 into contact with the end 571. All of the other embodiments described above can be provided in this “inverted” configuration with appropriate modification.

Further changes can be made within the scope of the invention.

1. A pressure activated non-contact seal for sealing against a rotating cylindrical surface between a high-pressure region and a low-pressure region, comprising:
a seal member carrier spaced radially from the rotating cylindrical surface and defining a seal member chamber in fluid communication with the high-pressure region;
a seal member supported by the seal member carrier so as to be moveable in a radial direction of the rotating cylindrical surface, and comprising non-contact seal surfaces adjacent to the rotating cylindrical surface; and
a secondary seal mounted between a surface of the seal member facing the seal member carrier and an opposed surface of the seal member chamber to provide a pressure barrier around the seal member between the high-pressure region and the low-pressure region;
wherein:
the seal member comprises side walls extending in the radial direction towards the rotating cylindrical surface and defining a seal cavity, the ends of the side walls adjacent to the rotating cylindrical surface defining non-contact seal surfaces; and
the seal member further comprises a bleed port extending between the seal cavity and the seal member chamber on the high-pressure side of the secondary seal such that in use, high pressure in the seal member chamber urges the seal member towards the rotating cylindrical surface until balanced by the pressure in the seal cavity to maintain the non-contact seal surfaces in a non-contact sealing relationship with the rotating cylindrical surface.

2. The seal as claimed in claim 1, wherein the rotating cylindrical surface is the outer surface of a rotating shaft or cylinder, or the inner surface of a rotating cylinder.

3. The seal as claimed in claim 1, wherein the seal member side walls are located at opposite ends of the seal member, and one or more intermediate walls are located between the side walls to define multiple seal cavities.

4. The seal as claimed in claim 3, further comprising a bleed port extending between each seal cavity and the seal member chamber around the seal member on the high-pressure side of the secondary seal.

5. The seal as claimed in claim 1, wherein the secondary seal is mounted on the seal member and is urged against the opposed wall of the seal member chamber.

6. The seal as claimed in of claim 1, wherein the secondary seal is mounted on the opposed wall of the seal member chamber and is urged against the surface of the seal member facing the seal member carrier.

7. The A seal as claimed in claim 1, wherein the secondary seal is located at a position between the high-pressure end and the-low pressure end of the seal member.

8. The seal as claimed in claim 1, wherein the surface of the seal member facing the seal member carrier is extended in a radial direction to define an axially-facing surface portion, the opposed surface of the seal member chamber has a corresponding axially-facing surface portion, and the secondary seal is mounted between the two axially-facing surface portions.

9. The seal as claimed in claim 1, wherein the seal member carrier comprises an end wall located at the low-pressure end of the seal member carrier and extending towards the shaft such that the low-pressure end of the seal member abuts against the end wall.

10. The seal as claimed in claim 9, wherein the end wall has a pocket formed facing the low-pressure end of the seal member carrier, wherein the pocket is in pressure communication with the seal member chamber outside the seal member on the high-pressure side of the secondary seal.

11. The seal as claimed in claim 10, wherein there is a pressure port extending between the pocket and the seal member chamber around the seal member on the high-pressure side of the secondary seal, or between the pocket and a seal cavity having a bleed port extending to the seal member chamber around the seal member on the high-pressure side of the secondary seal.

12. The seal as claimed in claim 9, wherein the seal member carrier end wall and the low-pressure end of the seal member are axially spaced from the non-contact seal surfaces.

13. The seal as claimed in any of claim 1, wherein the seal member carrier comprises an end wall located at the high-pressure end of the seal member carrier and extending towards the rotating cylindrical surface, and a leaf spring extends between the end wall and the high-pressure end of the seal member.

14. The seal as claimed in claim 13 wherein the leaf spring comprises a pair of leaf springs spaced apart in a radial direction.

15. A seal assembly comprising multiple seals as claimed in any claim 1 arranged circumferentially around the rotating cylindrical surface.

16. The seal assembly as claimed in claim 15, further comprising a seal carrier, wherein each seal comprises a formation that engages with a corresponding formation on the seal carrier to resist rotational movement of the seal.

17. The seal assembly as claimed in claim 15, further comprising springs between adjacent seals arranged to urge the adjacent seals apart.

18. The seal assembly as claimed in claim 15, wherein the edges of adjacent seals are stepped, and the stepped edges are inter-engaged to prevent a direct path extending between adjacent seals.

19. The seal assembly as claimed in claim 18, wherein the steps are in the radial and/or axial directions.
